(19) United States
(12) Patent Application Publication
(10) Pub. No.: US 2007/0260711 A1
(43) Pub. Date: Nov. 8, 2007

(54) System and method for configuring a station device to access an enterprise network

(76) Inventors: Parag Gupta, San Jose, CA (US); Dmitri Varsanofiev, San Diego, CA (US)

Correspondence Address: SHEMWELL MAHAMEDI LLP, 4880 STEVENS CREEK BOULEVARD, SUITE 201, SAN JOSE, CA, 95129, US

(21) Appl. No.: 11/370,209

(22) Filed: Mar. 6, 2006

Related U.S. Application Data
(60) Provisional application No. 60/779,157, filed on Mar. 4, 2006.

(51) Int. Cl. G06F 15/177

(52) U.S. Cl. 709/220

(57) ABSTRACT

A computing device may be configured to communicate with an enterprise network. A computer file may be generated from a remote resource for purpose of enabling configurations needed by the computing device to be pre-specified. The computer file may include a plurality of configuration items that are to be used with a network setup application, which is to be operated on the computing device. On the computing device, the network setup application is executable to enable connectivity between that computing device and the enterprise network through one or more network access points of the enterprise network. Once generated, the computer file can be transferred to the computing device. The network setup application may programmatically incorporate the configuration items of the computer file in its setup procedure for establishing connectivity between the computing device and one or more network access points.

### RELATED APPLICATION

This application claims benefit of priority to U.S. Provisional Application entitled System and Method for Configuring a Station Device to Access an Enterprise Network,” filed Mar. 4, 2006, naming P. Gupta as inventor. The aforementioned priority application has attorney reference number (PALM-0987 (4219.PALM.PRov); and it is incorporated by reference herein.

### TECHNICAL FIELD

The disclosed embodiments relate generally to the field of networking. In particular, the disclosed embodiments relate to a technique for configuring station devices for use with WI-Fi enterprise networks.

### BACKGROUND

Enterprise networks typically include networks of interconnected devices that share domain(s), or are otherwise under a common control or administration. Such networks are common with entities such as corporations or government agencies, where employees and other personnel use accounts and resources provided on the enterprise network.

Often, enterprise networks provide wireless connectivity within the geographic space where the enterprise network is centered, through use of Wireless Fidelity (“Wi-Fi” or 803.11b or 802.11g networks) connectivity. Such wireless connectivity enables personnel who are mobile to carry portable computing devices (e.g. laptops, smartphones and personal digital assistants) within the geographic space to remain connected. On enterprise networks, security (e.g. 802.1x based protocols) and account management make establishing Wi-Fi connectivity within enterprise networks more complex and sophisticated, often requiring use of cryptic syntax, data structures and configuration values. Such configuration data and procedures are often overly sophisticated for average users.

### BRIEF DESCRIPTION OF THE DRAWINGS

FIG. 1 illustrates a system for enabling a station device to access and use an enterprise network over a wireless fidelity connection, under an embodiment of the invention.

FIG. 2 illustrates methodologies by which one or more embodiments of the invention may be implemented, according to an embodiment of the invention.

FIG. 3 illustrates what kind of configuration items are contained in an output file, such as described above, under an embodiment of the invention.

FIG. 4A illustrates a user-interface as generated by a configuration application, under an embodiment of the invention.

FIG. 4B and FIG. 4C illustrate user-interfaces as generated by a setup application, under an embodiment of the invention.

FIG. 5 illustrates a hardware diagram for use with an embodiment of the invention.

### DETAILED DESCRIPTION

Embodiments described herein provide for configuring a station device, such as a mobile or portable computing device, to access an enterprise network through an intermediate network. The intermediate network may correspond to a network that enables an individual to roam within a site or location of the enterprise network.

According to an embodiment, a computing device may be configured to communicate with an enterprise network. A computer file may be generated from a remote resource for purpose of enabling configurations needed by the computing device to be pre-specified. In one embodiment, the computer file includes a plurality of configuration items that are to be used with a network setup application, which is to be operated on the computing device. On the computing device, the network setup application is executable to enable connectivity between that computing device and the enterprise network through one or more network access points of the enterprise network. Once generated, the computer file can be transferred to the computing device. The network setup application may programmatically incorporate the configuration items of the computer file in its setup procedure for establishing connectivity between the computing device and one or more network access points.

A method such as described in the preceding paragraph may be performed remotely from the computing device that is to be configured. In one embodiment, a method such as described may be performed on the terminal or work station of an administrator of an enterprise network, on behalf of a user of the enterprise network.

According to another embodiment, a computing device may be configured to communicate with an enterprise network by receiving a configuration file that includes a plurality of configuration items. A network setup application may be executed to enable connectivity with the enterprise network through one or more network access points of the enterprise network. Executing the network setup application includes automatically using configuration items from the computer file.

In one embodiment, a station device with Wi-Fi communication capabilities can be provided a data file for enabling automatic, or partially or substantially automatic, configuration and operation of a setup procedure for initiating recognition between the device and a Wi-Fi access point of the enterprise network. The configuration data, in connection with instructions that execute with a setup application, enable automation of certain steps in which a computing device is configured for a Wi-Fi network of a larger enterprise network. Such a setup procedure allows the station device (e.g, device on which wireless connectivity is provided) to connect and communicate with an enterprise network. Such communications, when performed through the setup procedure, can accommodate security settings, tunneling and other features that accompany the use of such wireless networks in an enterprise network setting.

Embodiments described herein provide for using pre-specified configuration data with a Wi-Fi (or other similar network) setup procedure. Such a network set up procedure may be performed to initiate ongoing wireless connectivity with an enterprise network, so that the user performing the setup requires no advanced knowledge or expertise performing the setup.

In one embodiment, data required for a Wi-Fi setup procedure is specified before a user initiates a setup procedure for the first time. In one embodiment, such data is provided to a station device prior to a setup procedure being performed, so that the Wi-Fi setup procedure becomes substantially automated. For example, under an embodiment, a user simply loads the configuration data as a file or otherwise, and then performs actions for connecting to a Wi-Fi access point of the enterprise network to perform the first Wi-Fi setup of the particular device with the enterprise network for the first time. For example, the user may simply bring the station device into range of an access point, where a Wi-Fi setup application automatically detects the access point and utilizes stored or pre-specified configuration data for the enterprise network to connect.

Numerous types of computing devices may be used with embodiments described herein. As mentioned, one type of computer telephony device for use with an embodiment is a wireless, mobile computing device, sometimes called the “smart phone” or hybrid devices. Such devices are generally small enough to fit in one hand, and provide cellular telephony features in combination with other applications, such as contact applications for managing contact records, calendar applications for managing and scheduling events, task applications for keeping lists, and camera applications for capturing images. Many types of messaging transports may be provided on such mobile computing devices, including SMS, MMS, email and instant messaging.

Other types of computing devices are contemplated for use with one or more embodiments described herein. Such computing devices include a desktop computer, laptop, personal digital assistant (PDA) or other computing device that can support messaging and messaging applications.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

Additionally, or more embodiments described herein may be implemented using modules. A module may include a program, a subroutine, a portion of a program, or a software component or a hardware component capable of performing one or more stated tasks or functions, or alternatively, a hardware component configured through software or other programmatic elements. As used herein, a module can exist on a hardware component independently of other modules, or a module can be a shared element or process of other modules, programs or machines.

The use of terms such as “component” or “element”, when presented in the context of software or programming, may refer to code that can be executed to perform a stated function or task. Such code may execute or be shared with other components or elements, even when a component or element is described or shown to be disparate from other components.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), Secure Digital (SD) memory cards, and magnetic memory. Computers, terminals, network enabled devices (e.g. mobile devices such as cell phones) are all examples of machines and devices that utilize processors, memory, and instructions stored on computer-readable mediums.

Overview

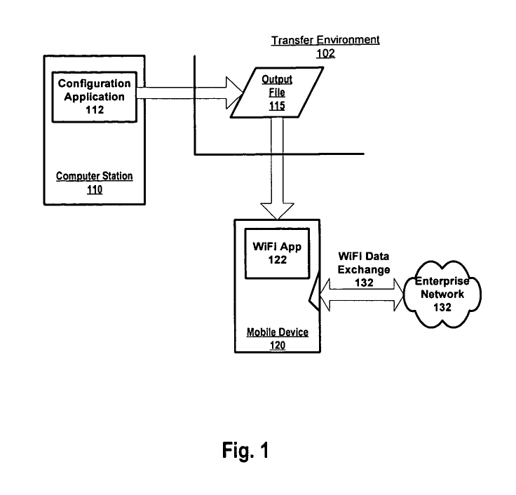

FIG. 1 illustrates a system for enabling a station device to access and use an enterprise network over a Wi-Fi connection, under an embodiment of the invention. A system includes a computer station 110 and a mobile device 120 (the station device) that can connect to and communicate with an enterprise network 132. In one embodiment, the computer station 110 is a network enabled computer, such as a desktop, laptop or workstation of an administrator or someone who can perform some of the operating tasks of an enterprise network. In an example provided, the mobile device may correspond to a personal digital assistant (PDA), hybrid cellular/PDA device, smart phone, laptop computer with wireless connectivity, or any other device capable of such network or wireless communications.

The mobile device 120 may include a Wi-Fi setup application 122 that can be executed one time (or intermittingly after certain events) to establish an available wireless connection between the device and the enterprise network 132. Once the available wireless connection is established, the mobile device 120 may have the ability to make future connections with the enterprise network 132 by simply communicating with an access point of the enterprise network. For example, once the initial setup is performed through use of the Wi-Fi setup application 122, future connections and wireless data exchange sessions may be conducted by a user simply bringing a mobile station in operative proximity of a wireless access point, or by a user performing a manual operation to trigger the connectivity when in range of the wireless access point.

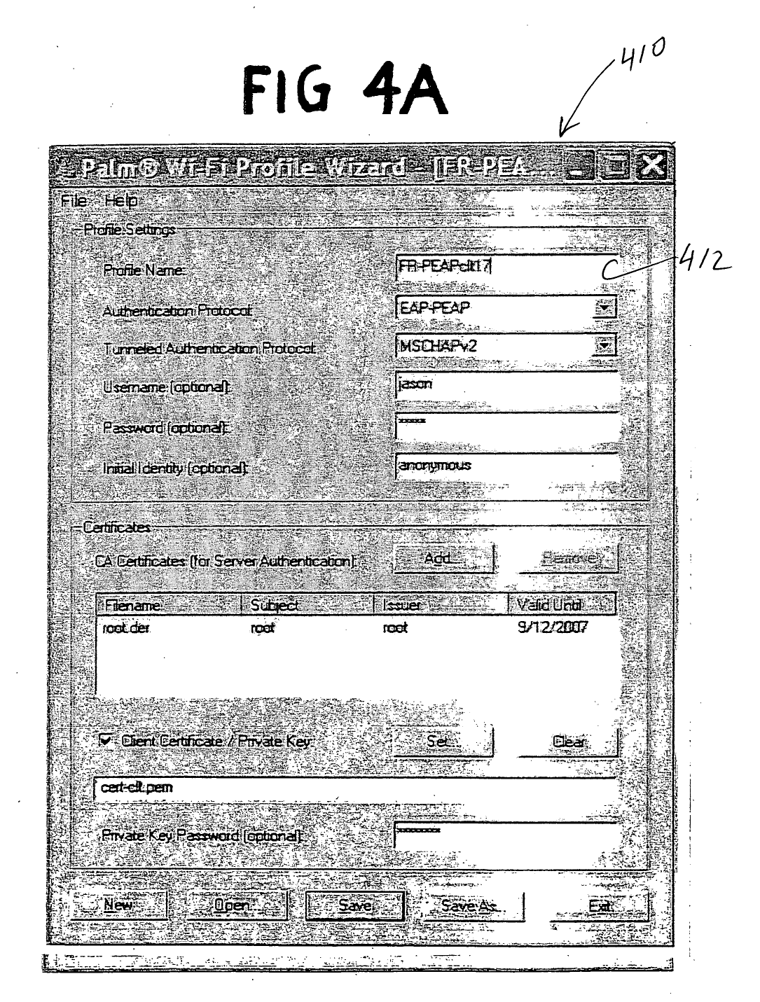

According to on embodiment, computer station 110 may generate an output file 115 that contains configuration data for use by a given class of computing devices (e.g. devices that operate a particular platform or run a particular setup application) or by an individual device. The computer station 110 may run a configuration application 112 that creates the output file 115 specifically for the Wi-Fi setup application 122 running on the mobile device 120. The configuration data contained in the output file 115 may contain all configuration data necessary for enabling a setup procedure initiated by the Wi-Fi setup application 122 to be successfully completed and connect to enterprise network 132. An example of the configuration data that can be contained in the output file 115 is shown with FIG. 3.

Under an embodiment, the configuration application 112 may be executed by an administrator of the enterprise network 132, or by someone who has sufficient knowledge of the enterprise network 132 to specify the various data items contained in the output file 115. As mentioned, once the output file 115 is created, it can be copied and used by multiple users of the enterprise network 132. For example, one configuration file can be copied and used by all users of the enterprise network 132, or by a class of users of that network (all those users who have a particular device and/or operating system platform, or run a specific Wi-Fi setup application). In one implementation, configuration application 112 may be in the form of a wizard or guide application, specifying prompts for entry of data items, and specifying a sequence by which the data items are to be submitted. In another implementation, configuration application 112 may be in the form of a software program (e.g. command line interpreter (cli)) to interpret the commands written as a software script. Once data items are entered by, for example, a network administrator, the application 112 generates the output file 115.

The configuration application 112 may automatically generate the output file 115 to have a format (e.g. date format), structure, and/or syntax that is recognizable and usable by the Wi-Fi setup application 122. For example, in an embodiment in which the mobile computing device 120 operates a PALM OS operating system, the file type of the output file 115 may correspond to PALMOSDatabase (“PDB”). To this end, one embodiment provides that the configuration application 112 is configured for a type or class of the setup procedure, so that the output file is indeed recognizable by the setup application 122. The output file 115 may be transferred, programmatically or manually, onto a transfer environment 102. The transfer environment 102 may correspond to any location that a user of the mobile device 120 can access and copy the output file 115. For example, the transfer environment 102 may correspond to a file location on a shared drive or directory of the enterprise network 132 (or other network), an email transmitted to an email address that the mobile device 120 can access, a secure digital (SD) card or other portable memory that can be inserted into the mobile device, or other location that can communicate data to the mobile device 120 (or even another device under the control of a common user).

From the transfer environment 102, the output file 115 may be copied to reside on the mobile device 120. On an instance when a Wi-Fi setup is first performed, using the WiFi access point of the enterprise network 132, the output file 115 may be called or otherwise used by the setup application 122. In one embodiment, individual configurations contained in the output file 115 are carried into the setup application 122 to enable completion of the initial setup procedure. As mentioned, once the initial setup procedure is performed, the mobile device 120 may be brought into connectivity with the enterprise network 132 through a Wi-Fi data exchange 134. The user may simply walk into proximity of an access point, or manually initiate the exchange when in range. While under one implementation, the Wi-Fi data exchange 134 is convention, the initial setup procedure is greatly simplified and not repeated.

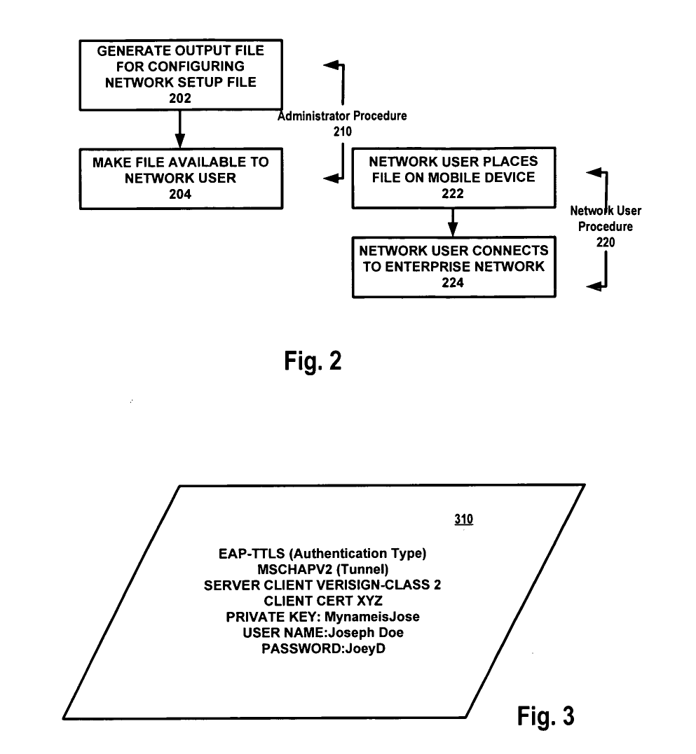

FIG. 2 illustrates methodologies by which one or more embodiments of the invention may be implemented, according to an embodiment of the invention. A method such as described may be performed to enable a setup application (e.g. Wi-Fi setup application 122) to use pre-specified configuration data stored electronically, so that the user is not burdened with the task of providing such data himself. Accordingly, an embodiment such as described with FIG. 2 may be performed using a system such as described in FIG. 1.

In an embodiment, a method such as described by FIG. 2 may include an administrator procedure 210 and a network user procedure 220. In the administrator procedure 210, a person such as an administrator (or a technical operator of a pertinent network) performs a step 202 of generating an output file for use in configuring a setup application. In one embodiment, step 202 is performed at least in part through use of a program, such as an application wizard, where such data prompts or guides the user for data items that correspond to individual configuration parameters for use with the setup application 122. Once the output file containing the configurations is generated, step 204 provides that the output file is made available to network users. As described, step 204 may be performed by, for example, (i) making the file available for access on a shared directory or network drive, (ii) providing the file on a computer-readable medium (e.g. on an SD card), or (iii) transmitting the file to the user and/or computer that is to use the file. In a network user procedure 220, a step 222 provides that a network user places a file on one or more mobile devices. For example, the user may possess more than one device that he or she wants to make connectable via Wi-Fi to an enterprise network, in which case the user may place a copy of the file on each of the multiple devices. Step 224 provides for a network user to connect to an enterprise network and perform the setup procedure once the output file with the configuration data items are on the device. Thus, once the user places the output file on the device, the user still needs to run setup. In order to run the setup, the user may need to access the Wi-Fi connection of the enterprise network and initiate the setup procedure. As part of this step, a user may enter an operational range of a local Wi-Fi network and perform a step of scanning for the available network. One implementation provides that the setup application (e.g. Wi-Fi setup application 122) automatically loads configuration data from the output file upon the scan being performed, or simply upon the user entering the vicinity of the network.

From the perspective of an administrator, for example, an embodiment may appreciate that the administrator may need to specify configuration items for a setup procedure such as described just one time. An output of the setup procedure may accommodate numerous users of an enterprise network. As such, the work load for configuring multiple devices for local Wi-Fi connectivity to an enterprise network is greatly reduced.

FIG. 3 illustrates what kind of configuration items are contained in an output file, such as described above, under an embodiment of the invention. An output file 310 may contain a plurality of configuration items 312, of which at least some are specified by a person. This person may correspond to, for example, an administrator of an enterprise network for which connectivity is sought.

Examples of the configuration data 312 include: authentication type, tunnel data, security certificates data including any private key and its value, initial identity, and optionally the network user's username and password. In one embodiment, some of the configuration data 312, such as username and password, is entered by the user of the computing device seeking Wi-Fi connectivity, and not the administrator. This allows the administrator to create one file containing more sophisticated configuration data, and enabling the user to enter during the setup procedure more simple data such as username and password (which the user can create during the setup procedure). In another embodiment, such information may be entered by the user after the first setup is performed.

In an embodiment such as shown by FIG. 3, the output file 310 contains limited or no intelligence, but rather presents values that are interpreted and used by instructions executed as part of the setup application. In another embodiment, the output file 315 may be intelligent or programmatic in nature, so that its use by the setup application enables more intelligent configurations or operations to take place. For example, multiple platforms may be accommodated by instructions that can be included in the file 310.

What one or more embodiments provide is the establishment of an auto-configuration file for use with a Wi-Fi setup application. The auto-configuration file (or quasi-auto-configuration file) enables the user of a computing device that is to perform an initial network setup procedure (such as the Wi-Fi example of FIG. 1) to avoid having to manually enter some or all of the data needed to make the setup successful. In one embodiment, all data, but for user name and password is provided from the file. The other data may be entered manually, or carried on the device and provided otherwise.

At the same time, an embodiment provides that a single file is capable of being used by multiple users for purpose of configuring a setup procedure for establishing initial connectivity with an enterprise network, such as described with an embodiment provided above. This allows administrative work of enabling individual devices to be scaled: for example, one file can service numerous users and devices for the enterprise network.

Moreover, a computing device may carry more than one configuration file for Wi-Fi access points of different access points. For example, a user may use one output file of configuration data for a first enterprise network, then travel as a guest to another location of another enterprise network. At the other location, the user may have utilize the same setup application, but use a different output file of configuration data.

Among other uses, embodiments described herein enable accommodation of guest users at the location of an enterprise network. For example, an enterprise network site often accommodates guests who are to be provided certain network privileges (e.g. contractors etc.). The duration of the visit time by such individuals may often be measured by hours or days, and with the widespread use of mobile computing devices, it is often advantageous, if not hospitable, to enable at least limited network connectivity to such individuals. In one embodiment, such a guest user may enter the site of an enterprise network and be provided a file for a guest user access session. The file may be communicated to the user through various means, such as through Bluetooth connectivity with another station, through an email, or otherwise. Once the guest user has the file, he can initiate a setup procedure using the configuration data provided on the output file provided him, and thus have access to an enterprise network through a Wi-Fi access point.

In an embodiment such as provided, additional network protection may be achieved in that the guest user may be shielded from seeing many of the configurations used for enabling the setup procedure. Thus, the user may be denied the ability to copy the configuration data for use on a device when entering the premise of the enterprise network, unless the operator(s) of the enterprise network expressly provide him the output file. To this end, the configuration data of the output file may be encrypted, and the setup application that uses the configuration data may be provided an encryption key programmatically or otherwise.

With reference to FIG. 3, the output file 115 may accommodate numerous types of Authentication Protocols. For example, an administrator of the enterprise network may be promoted to enter information about an authentication protocol in a field provided by the configuration application 112. This value may correspond to, for example, any of the following authentication protocols: EAP-TLS (“Extensible Authentication Protocol-Transport Layer Security”), EAP-TTLS (“EAP Tunneled TLS Authentication Protocol”), EAP-PEAP and LEAP (“Light Extensible Authentication Protocol”).

With regard to tunneling protocol, the entries may be provided by a network administrator, based on, for example, the choice of Authentication Protocol (see above). For example, the administrator may enter as a field value “EAP-TLS” or “LEAP”, in which case no tunnel protocol is necessary for the enterprise network. When this value is entered, the field for the tunneling protocol is inactive. Alternatively, a specific tunneling protocol may be used in the case where the value entered, such as, for example: EAP-TTLS: PAP (“Packet Authentication Protocol”), CHAP (“Challenge-Handshake Authentication Protocol”), MSCHAP (“Microsoft Challenge Handshake Authentication Protocol”), MSCHAPv2 (“Microsoft Challenge Handshake Authentication Protocol version 2”), EAP-GTC (password), EAP-MD5-Challenge (“Extensible Authentication Protocol-Message Digest 5-Challenge”), EAP-MSCHAPv2, EAP-PEAP (“Extensible Authentication Protocol-Protected Extensible Authentication Protocol”): MSCHAPv2, GTC (password).

Another set of fields or values for configuration items that can be handled by output file 115 are those for username and password. In one embodiment, these fields are optional. For example, on a RADIUS type server, separate fields may be provided for designation of a user's username and password. The administrator may leave these fields blank, in which case the user may fill out these fields on the device (based on Authentication Protocol selection) to connect successfully. Such fields may not be active for some protocols, such as LEAP.

Another field or configuration item may correspond to initial identity. To keep the client identity secure from eavesdropping, this field may be used to log in anonymously and establish the tunnel. The actual login name and client credentials may then be passed through the secure tunnel. Such an approach may have particular application to the tunneled EAP-TTLS and EAP-PEAP protocols. The default value for this field must be left blank. The value for this initial identity is provided by the network administrators, typical values are “anonymous”, (e.g. anonymous@<company_name>.com”) or it can left blank. If the field is left blank, then the actual login name is also used to establish the tunnel.

Another configuration item that can be included in the output file 115 is a server certificate. For example, an administrator of the network may be enabled to select one of a plurality of certificates. In one implementation, a default file mask for CA certificate files must be set to “X.509 Certificate (*.der, *.cer, *.crt)”, and a user may have an option to change the file mask to “All Files (*.*)”. A certificate may also be removed from a profile created by the user (e.g. a listing of all configuration items in the output file 115).

One or more embodiments may provide a feature for a user to specify a client certificate. The selection for enabling such a feature may depend on the authentication method or protocol in place. For some authentication protocols (such as EAP-TLS), the client certificate may be a required field. For other methods, the client certificate can be set through selection of a user/administrator. In one implementation, once the check-box is selected, a “set” or “clear” (or similar equivalents) feature may be activated. A “Set” feature may be selected by, for example, a corresponding check-box that is checked. This allows an administrator to set the client certificate for an individual user. A default file mask may also be employed. The user must have an option to change the file mask to “All Files (*.*)”. With regard to a “Clear” feature, selection clears the client certificate that has been set before for an individual user.

User-Interfaces

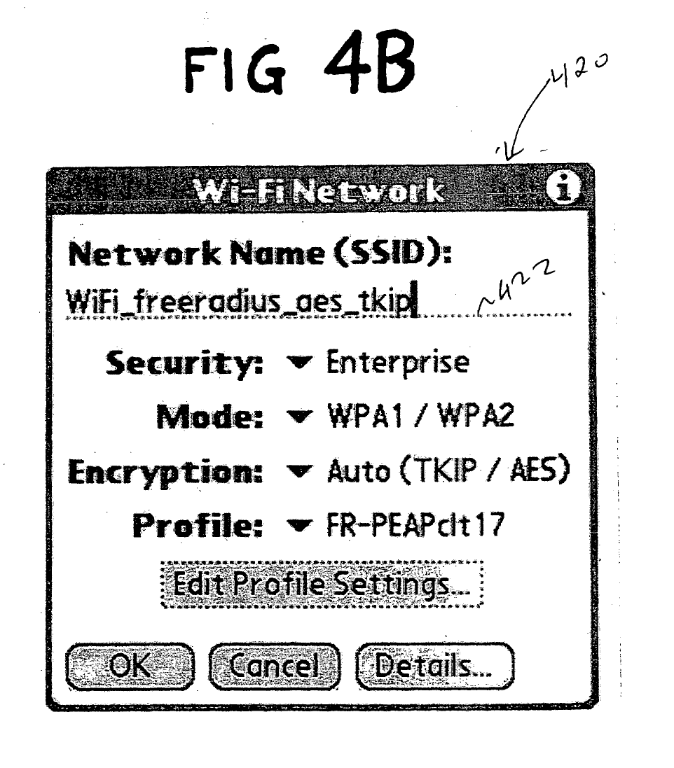

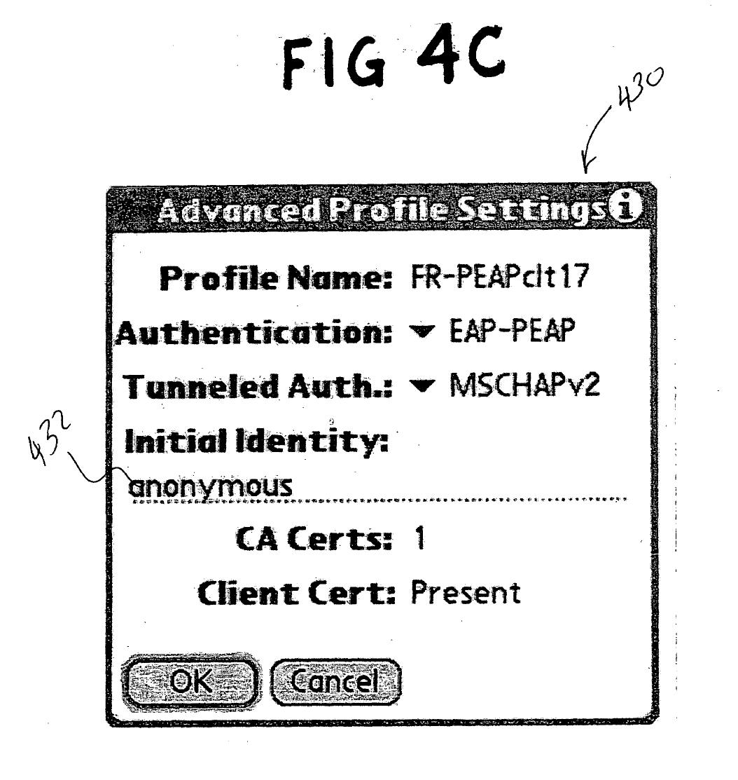

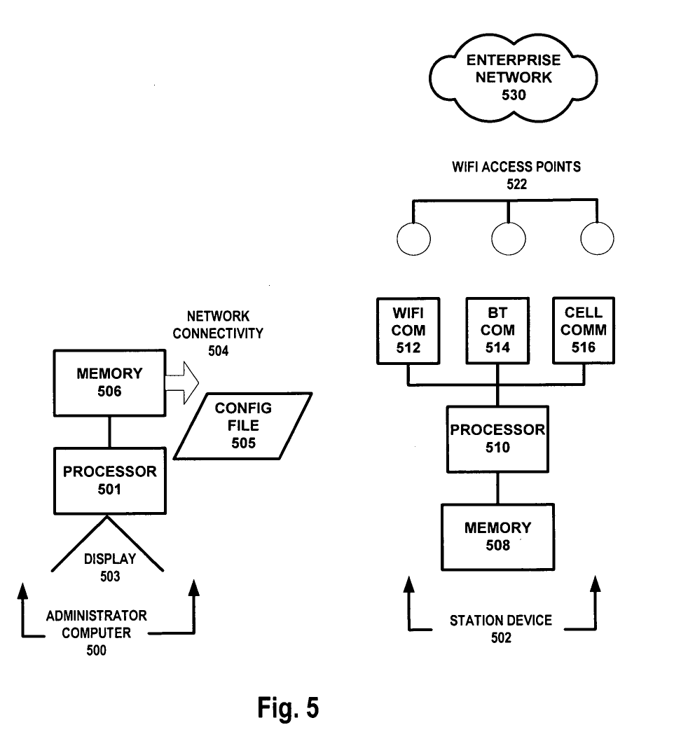

FIG. 4A illustrates a user-interface as generated by configuration application 112 (FIG. 1), under an embodiment of the invention. A user-interface 410 such as shown may be executed on an administration computer (such as shown in FIG. 5) as part of an administrative procedure to provide one output file 115 (FIG. 1) for use by computing devices of many users. In an embodiment, the user-interface 410 includes a plurality of fields 412 that enable an administrator to enter manually, or select from menu items, various field values such as specified by FIG. 3. Included in the various fields that can be specified is a private key password, to protect the output file from use by non-authorized users.

FIG. 4B and FIG. 4C illustrate user-interfaces that can be generated by a setup application (e.g. “WiFi application 122” of FIG. 1) when the output file 115 (FIG. 1) is used to perform an initial setup with an access point of an enterprise network, under an embodiment of the invention. In FIG. 4B, a user-interface 420 includes an identification field 422 for which the user of the station device may provide the name of the network of access points 522 (see FIG. 5). In one implementation, for example, the name of the network of access points 522 correspond to a local WiFi network may be provided by the user, after he performs a scan for the networks in the area. Alternatively, the name may be imported into the field after the scan is performed.

In one embodiment, values of fields provided by the administrator are displayed in corresponding fields 422 on the user-interface 420. The values may be changed through manual entry or pull-down menu through inputs of the user of the station terminal. Alternatively, the user may edit the settings through another manual edit selection 424.

FIG. 4C illustrates another user-interface 430 provided on the computing device that is to be configured, where the user enters more advanced settings, under an embodiment of the invention. An initial identity filed 432 may be altered (or completed) by the user. User-interface 430 may be employed by, for example, an advanced user, or the network administrator.

Hardware Diagram

FIG. 5 illustrates a hardware diagram for use with an embodiment of the invention. A system may be established by an administrator computer 500 and one or more station terminals 502. In one implementation, numerous station terminals are contemplated (e.g. hundreds or thousands), but only one station terminal 502 is shown and described as being representative of other station terminals. One aspect of an embodiment is an administrator computer 500, which may include, for example, a work station or personal computer. The administrator computer 500 may include a processor 501 that executes instructions comprising or corresponding to a configuration application 505 for purpose of enabling a network administrator to configure the output file 115 (FIG. 1). A memory 505 (or any other form of computer-readable medium) may store the instructions corresponding to the configuration application 505. A network connectivity component 504 may enable the administrator to make the configuration application 505 available for transfer or download to the users of the station device 502.

Station terminal 502 may include memory 508, a processor 510, and one or more types of roaming network connectivity, shown in FIG. 5 to include: WiFi communication component 512, Bluetooth communication port 514, and cellular communication port 516 (e.g. cellular data broadband). Memory 508 may store instructions corresponding to a roaming network setup application, such as shown in FIG. 1 (e.g. WiFi setup application 122). In addition, memory 505 may store the configuration file 505 when it is transferred, although alternative variations contemplate its transfer through a portable memory (e.g. “SD card”). The processor 510 may execute the stored instructions as part of an initial roaming network setup process. Execution of the instructions may cause importation of values provided by the configuration file 505. Execution of the instructions may cause a network setup process to be performed to establish subsequent network connectivity with enterprise network 530, where the connectivity may be established through one of the communication components (e.g. WiFi communication port 512) communicating to the enterprise network 530 through an access point 522 (shown in the example provided as “WiFi access points”).

Alternatives

While embodiments described herein are specific to application in Wi-Fi, embodiments described herein may extend to any network procedure or setup procedure. In some embodiments, computing devices may be provided auto-configuration files that can be used with just about any network setup procedure, including procedures to enable individuals to roam with a site or location.

Furthermore, while embodiments described herein specifically recite Wi-Fi setup procedures for gaining access to an enterprise network, one or more embodiments contemplate providing configuration data in a file for Wi-Fi setup procedures for connectivity to other networks, such as broadband Internet locals (e.g. “HotSpots”). In the latter case, procedures that the user would have needed to perform manually to logon through a hot spot may be performed automatically, through, for example, use of a configuration data file.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventor from claiming rights to such combinations.

1. A method for configuring a computing device to communicate with an enterprise network, the method comprising:
generating, remote to the computing device, a computer file that includes a plurality of configuration items for use with a network setup application, wherein network setup application is executable on the computing to enable connectivity between the computing device and the enterprise network through one or more network access points of the enterprise network; and
enabling the computer file to subsequently be transferred to the computing device, so that the computer file is programmatically usable by the network setup application of the computing device to perform a setup procedure for establishing connectivity between the computing device and the one or more network access points.

2. The method of claim 1, wherein generating a computer file includes generating the computer file for a roaming network setup application.

3. The method of claim 1, wherein generating a computer file includes generating the computer file for a local wireless network setup application.

4. The method of claim 3, wherein the local wireless network setup application is for a Wireless Fidelity application.

5. The method of claim 1, wherein enabling the file to subsequently be transferred to the computing device includes storing the computer file on a directory that is available to users of the enterprise network.

6. The method of claim 1, wherein enabling the file to subsequently be transferred to the computing device configuring the file to be programmatically readable by network setup application.

7. The method of claim 1, wherein enabling the file to subsequently be transferred to the computing device includes enabling a user to store and transfer the file using a portable memory device.

8. The method of claim 1, wherein enabling the file to subsequently be transferred to the computing device includes transmitting the file with an electronic message to the user.

9. The method of claim 1, wherein generating a computer file includes generating a file comprising a plurality of alphanumeric values that specify individual network configurations that are required during the setup procedure.

10. The method of claim 9, wherein the plurality of alphanumeric values specify one or more of an authentication protocol and a tunneling protocol.

11. A method for configuring a computing device to communicate with an enterprise network, the method comprising:
receiving a computer file that includes a plurality of configuration items; and
executing a network setup application to enable connectivity with the enterprise network through one or more network access points of the enterprise network, wherein executing the network setup application includes automatically using configuration items from the computer file.

12. The method of claim 11, further comprising scanning for a local wireless network, and wherein executing the network setup application includes executing an application for performing a setup procedure with the wireless network.

13. The method of claim 12, wherein the wireless network is Wireless Fidelity network.

14. The method of claim 11, wherein receiving a computer file includes receiving a file comprising a plurality of alphanumeric values that specify individual network configurations.

15. The method of claim 14, wherein the plurality of alphanumeric values specify one or more of an authentication protocol and a tunneling protocol for use with a wireless network of the enterprise network.

16. The method of claim 12, wherein executing an application for performing a setup procedure with the wireless network includes executing the application to perform at least some of the steps in the setup procedure automatically.

17. The method of claim 16, wherein executing the application to perform at least some of the steps in the setup procedure automatically includes enabling a user of the computing device to enter a username and/or password.

18. A method for configuring a plurality of computing device to communicate with an enterprise network, the method comprising:
generating a computer file that includes a plurality of configuration items for use with a network setup application, wherein the network setup application is executable on any given computing device in the plurality of computing devices to enable connectivity between the given computing device and the enterprise network through one or more network access points of the enterprise network; and
enabling the computer file to subsequently be transferred to any of the plurality computing device, so that the computer file is usable by the network setup application when executed on each computing device that is transferred the computer file to perform a setup procedure for establishing connectivity between that computing device and the one or more network access points.

19. The method of claim 18, wherein generating a computer file that includes a plurality of configuration items for use with a network setup application includes generating the computer file for a Wireless Fidelity setup application.

20. A computer readable medium carrying instructions for configuring a computing device to communicate with an enterprise network, wherein the instruction include instructions that when executed by one or more processors, cause the one or more processors to perform steps comprising:
generating a computer file that includes a plurality of configuration items for use with a network setup application, wherein network setup application is executable on the computing device of each user in a plurality of users so as to enable connectivity between that user and the enterprise network through one or more network access points of the enterprise network; and
enabling the computer file to subsequently be transferred to the computing device of one or more users in the plurality of users, so that the computer file is usable by the network setup application of each computing device to perform a setup procedure for establishing connectivity between the computing device and the one or more network access points.
